(19) United States
(12) Patent Application Publication
(10) Pub. No.: US 2005/0157809 A1
(43) Pub. Date: Jul. 21, 2005

(54) Decoding apparatus and method of MIMO system

(75) Inventor: Young-soo Yuk, Seoul (KR)

Correspondence Address: JONATHAN Y. KANG, ESQ.;LEE, HONG, DEGERMAN, KANG & SCHMADEKA, P.C., 14th Floor, 801 S. Figueroa Street, Los Angeles, CA, 90017-5654, US

(73) Assignee: LG Electronics Inc.

(21) Appl. No.: 11/040,852

(22) Filed: Jan. 20, 2005

Related U.S. Application Data
(60) Provisional application No. 60/537,491, filed on Jan. 20, 2004.

(30) Foreign Application Priority Data
Feb. 10, 2004 (KR) 10-2004-0008778

(51) Int. Cl. H04L 1/02

(52) U.S. Cl. 375/267

(57) ABSTRACT

An apparatus and method for decoding a MIMO system are disclosed. By employing an SIC(Successive Interference Cancellation)-based iterative decoding algorithm in the T-BLAST system or by applying the SIC-based iterative decoding algorithm in combination with PIC(Parallel Interference Cancellation) to the T-BLAST system, a high order of modulation method can be used or a high performance gain can be obtained in a transmission system having multiple antennas. Especially, by combining the SIC to the PIC, merits of the two schemes have a synergy effect of obtaining high bit error performance in various wireless environments.

### BACKGROUND OF THE INVENTION

1. Field of the Invention

The present invention relates to a MIMO (Multiple Input Multiple Output) system and, more particularly, to a TBLAST technique of the MIMO system.

2. Description of the Related Art

The next-generation mobile communication system requires an advanced communication method in order to support various services including diverse combined data and high quality and high speed data. For this requirement, recently, interests on time-space processing are increasing, and researches on a MIMO system are actively ongoing, following researches on space time codes or the like. The Bell Institute has implemented space multiplexing known as BLAST (Bell-lab LAyered Space-Time architecture). The BLAST is an important technique for its offering of extremely large spectral efficiency. The original spatial multiplexing system is D (diagonal)-BLAST, which was proposed by G. J. Foschini.

D-BLAST makes efficient use of the spatial diversity by concatenating spatial multiplexing and channel coding. However, D-BLAST suffers from boundary wastage at the start and the end of each frame, which becomes significant for a large packet size. V (Vertical)-BLAST overcomes this limitation by using a simple vector coding.

Because it excludes the channel coding, it does not utilize the spatial diversity despite of its potential possession of the spatial diversity. Moreover, it suffers from the problem of performance degradation by canceling error.

Iterative decoding can be applied as a solution of this error propagation problem. Among related arts, turbo-BLAST which was proposed by M. Sellathurai is considered as one of the most successful one. T-BLAST is a concatenation structure of BLAST and the channel coding and employs a parallel interference cancellation (PIC) scheme as a BLAST decoder. The V-BLAST employs a successive interference cancellation (SIC) scheme.

Though the PIC-based turbo-BLAST achieves outstanding performance gains, the effect of the interference detection errors is more serious on PIC scheme than SIC scheme because of canceling error propagation.

For the sake of explanation, the PIC-based iterative decoded MIMO system is denoted by PIC-TBLAST and the SIC-based iterative decoded MIMO system is denoted by SIC-TBLAST.

FIG. 1 is a block diagram showing the structure of a related art PIC-TBLAST system. A mobile communication system described hereinafter is assumed as a MIMO system which has the M number of transmit antennas and N number of receive antennas.

As shown in FIG. 1, a transmitter 100 includes a channel encoder 10, an interleaver and a BLAST spatial multiplexing transmitter 30.

Conceptually, the channel encoder 1 and the spatial multiplexing transmitter 30 of the transmitter 100 can be understood as an outer encoder and an inner encoder of a serial concatenation coding. The random interleaver 20 is interposed between the channel encoder 10 and the spatial multiplexing transmitter 30 to improve performing of iterative decoding.

A receiver 200 includes a BLAST decoder 230, a deinterleaver 220 and a channel decoder 210 corresponding to the transmitter 100.

As the channel decoder 210, any decoder can be used so long as it can output a soft decision result, and in the present invention, a SISO (Soft-Input Soft-Output) decoder is used. For the iterative decoding, an output of the channel decoder 210 is re-inputted to the BLAST decoder 230 through the interleaver 240.

In general, the transmitter 100 applies an individual code to a bit stream transmitted to each antenna and distributes it by using a spatial interleaver, but in the related art with reference to FIG. 1, the structure of the transmitter 100 is generalized to have a structure that the a bit stream transmitted to each antenna is encoded to one channel code and then distributed to an interleaver and a serial/parallel converter. Such modification on the structure is a matter of implementation irrespective of performance.

The operation of the transmitter 100 and the receiver 200 will be described as follows.

The transmitter 100 performs transmission by units of frame. A frame passes through the channel encoder 10 and the interleaver 20 and to the M number of antennas. The distributed M number of signals are modulated and transmitted through a MIMO channel, respectively.

The receiver 200 extracts transmission symbols (M number of symbols) from a signal vector received, respectively, by the N number reception antennas and then decoded. The decoded symbols pass through the deinterleaver 200 to be transferred to and decoded in the channel decoder 210. At this time, the channel decoder 210 generates a reliability value with respect to the inputted symbol and transmits the reliability value to the BLAST decoder 230 via the interleaver 240.

The reliability value transmitted to the BLAST decoder 230 is generally called extrinsic information, and the BLAST decoder 230 uses it as a priori probability for decoding a maximum a posteriori (MAP) probability. This process is repeatedly performed and the number of times of repeating can be adjusted by the system. The T-BLAST system basically uses the BLAST decoder based on the PIC scheme.

FIG. 2 shows the PIC scheme of the T-BLAST. The operation of the T-BLAST system will be described as follows with reference to FIG. 2.

A. First Receiving (Decoding)

The BLAST decoder 230 extracts the M number of transmission symbols from a signal vector (x) which has been received by the N number of reception antennas, and decodes them. For the decoding of symbols, a nulling vector obtained from a channel matrix is used, and in this case, the nulling vector can be implemented as a zero-forcing (ZF) or a minimum mean squared error (MMSE) estimator). A nulling vector for the mth (m: 1˜M) symbol can be obtained by equation (1) shown below:
ZF: wₘ=[(HH^{H})⁻¹H^{H}]_{m-th row}
MMSE: wₘ=[(HH^{H}+σ²I)⁻¹H^{H}]_{m-th row} (1)
wherein ‘H’ indicates a channel matrix, H^{H} indicates a Hermitian matrix of the matrix H and a indicates power of noise.

An output signal (yₘ) of the BLAST decoder 230 is inputted to the channel decoder 210 after passing through the deinterleaver 220, and the channel decoder 210 generates a reliability value (Lₘ), which will be referred to as ‘extrinsic information’, hereinafter) with respect to the inputted signal, and inputs it to the BLAST decoder 230.

B. Iterative Decoding

In iterative decoding, there exists extrinsic information (Lⱼ), so the BLAST decoder 230 computes E(sⱼ), a mean value of an interference signal, by using the extrinsic information (Lⱼ) and multiplies the mean value (E(sⱼ)) and a channel matrix (H) to cancel an interference signal of the receiving vector.

If the modulation method is a binary phase shift keying (BPSK), a computation equation of the mean value (E(sⱼ)) is tanh(Lⱼ/2), and in case of a quadrature phase shift keying (QPSK), a computation equation of the mean value (E(sⱼ)) is (tanh(L_{j,1}/2)jtanh(L_{j,2}/2))/sqrt(2)).

And then, a nulling vector is multiplied to the interference signal-canceled signal to decode a symbol. The decoded symbol (yₘ) is deinterleaved and then transferred to the channel decoder 210. Then, the channel decoder 210 generates extrinsic information again and inputs it to the BLAST decoder 230.

The above-described related art has the following problems

First, since the related art T-BLAST system has severe error propagation according to the PIC at a low signal-to-noise ratio, it has worse performance than the case of employing the iterative decoding method.

Second, the more the number of antennas increases and the higher the order of modulation increases, interference canceling error propagation becomes severe, performance is considerably degraded. In addition, the more the number of antennas increases, complexity of the PIC is much increased.

### SUMMARY OF THE INVENTION

Therefore, one object of the present invention is to provide an apparatus and method for decoding a MIMO system employing an SIC-based iterative decoding algorithm.

Another object of the present invention is to provide an apparatus and method for decoding a MIMO system employing an iterative decoding algorithm based on a hybrid interference cancellation scheme combining an SIC and a PIC.

To achieve at least the above objects in whole or in parts, there is provided a receiving apparatus of a MIMO system including a decoding unit for performing iterative decoding based on a serial concatenation interference cancellation scheme by using a reception signal vector and a reliability value; a converting unit for converting an output of the decoding unit into a serial signal; a deinterleaving unit for deinterleaving the serial signal; and a channel decoding unit for obtaining a reliability value with respect to an output signal of the deinterleaving unit and outputting the reliability value to the decoding unit.

Preferably, the decoding unit includes an ordering unit for selecting a layer with the lowest symbol error probability by using the reliability value and a channel vector; a nulling unit for performing nulling on the selected layer; a slicing unit for re-generating a symbol corresponding to a result value of the nulling; a canceling unit for canceling a symbol corresponding to an interference signal, among re-generated symbols, from the reception signal.

To achieve at least these advantages in whole or in parts, there is further provided a decoding method of a MIMO system including: performing iterative decoding based on a serial concatenation interference cancellation scheme by using a reception signal vector and a reliability value; converting the decoded signal into a serial signal; deinterleaving the serial signal; and obtaining a reliability value of the deinterleaved signal and feeding the reliability value back to the iterative decoding step.

Preferably, the iterative decoding includes: performing ordering to select a layer with the lowest symbol error probability by using the reliability value and a channel vector; performing nulling on the selected layer; performing slicing to re-generate a symbol corresponding to a result value of the nulling; and canceling a symbol corresponding to an interference signal, among re-generated symbols, from the reception signal.

To achieve at least these advantages in whole or in parts, there is further provided a receiving apparatus of a MIMO system including: a decoding unit for estimating an interference signal by performing serial interference cancellation scheme-based iterative decoding and performing parallel interference cancellation scheme-based iterative decoding based on the estimated value; a converting unit for converting an output of the decoding unit into a serial signal; a deinterleaving unit for deinterleaving the serial signal; and a channel decoding unit for obtaining a reliability value of an output signal of the deinterleaving unit and outputting the reliability value to the decoding unit.

Preferably, the decoding unit includes a first decoding means for performing serial concatenation interference cancellation scheme-based iterative decoding by using a reception signal vector and the reliability value, and estimating an interference signal; and a second decoding means for performing parallel concatenation interference cancellation scheme-based iterative decoding by using the reception signal vector and the estimated value of the first decoding means, and estimating an actual symbol.

Preferably, the first decoding means includes: an ordering unit for selecting a layer with the lowest symbol error probability by using the reliability value and a channel vector; a nulling unit for performing nulling on the selected layer; a slicing unit for re-generating a symbol corresponding to a result value of the nulling; and a canceling unit for canceling a symbol corresponding to an interference signal, among re-generated symbols, form the reception signal.

To achieve at least these advantages in whole or in parts, there is further provided a decoding method of a MIMO system including: estimating an interference signal by performing serial interference cancellation scheme-based iterative decoding, and performing parallel interference cancellation scheme-based iterative decoding based on the estimated value; converting the decoded signal into a serial signal; deinterleaving the serial signal; and feeding a reliability value of the deinterleaved signal back to the iterative decoding based on a serial interference cancellation scheme.

Preferably, the iterative decoding includes: performing serial concatenation interference cancellation scheme-based iterative decoding by using a reception signal vector and the reliability value, and estimating an interference signal; and performing parallel concatenation interference cancellation scheme-based iterative decoding by using the reception signal vector and the estimated value, and estimating an actual symbol.

Preferably, the iterative decoding based on a serial interference cancellation includes: performing ordering to select a layer with the lowest symbol error probability by using the reliability value and a channel vector; performing nulling on the selected layer; performing slicing to re-generate a symbol corresponding to a result value of the nulling; and canceling a symbol corresponding to an interference signal, among re-generated symbols, from the reception signal.

Additional advantages, objects, and features of the invention will be set forth in part in the description which follows and in part will become apparent to those having ordinary skill in the art upon examination of the following or may be learned from practice of the invention. The objects and advantages of the invention may be realized and attained as particularly pointed out in the appended claims.

### BRIEF DESCRIPTION OF THE DRAWINGS

The invention will be described in detail with reference to the following drawings in which like reference numerals refer to like elements wherein:

FIG. 1 illustrates a transmitter and a receiver of a T-BLAST system;

FIG. 2 illustrates a decoding process of the T-BLAST in accordance with a parallel interference cancellation scheme;

FIG. 3 illustrates a decoding process of the T-BLAST in accordance with a serial interference cancellation scheme;

FIG. 4 illustrates a decoding process of the T-BLAST according to a hybrid interference cancellation scheme;

FIG. 5 is a graph showing a result of a first simulation (4×4 MIMO with BPSK modulation);

FIG. 6 is a graph showing a result of a second simulation (4×4 MIMO with QPSK modulation);

FIG. 7 is a graph showing a result of a first simulation (4×4 MIMO with 16-QAM (Quadrature Amplitude Modulation);

FIG. 8 is a graph showing a result of a first simulation (8×8 MIMO with BPSK modulation);

FIG. 9 is a graph showing a result of a first simulation (8×8 MIMO with QPSK modulation); and

FIG. 10 is a graph showing a result of a first simulation (8×8 MIMO with 16-QAM).

### DETAILED DESCRIPTION OF THE PREFERRED EMBODIMENTS

A preferred embodiment of the present invention will now be described.

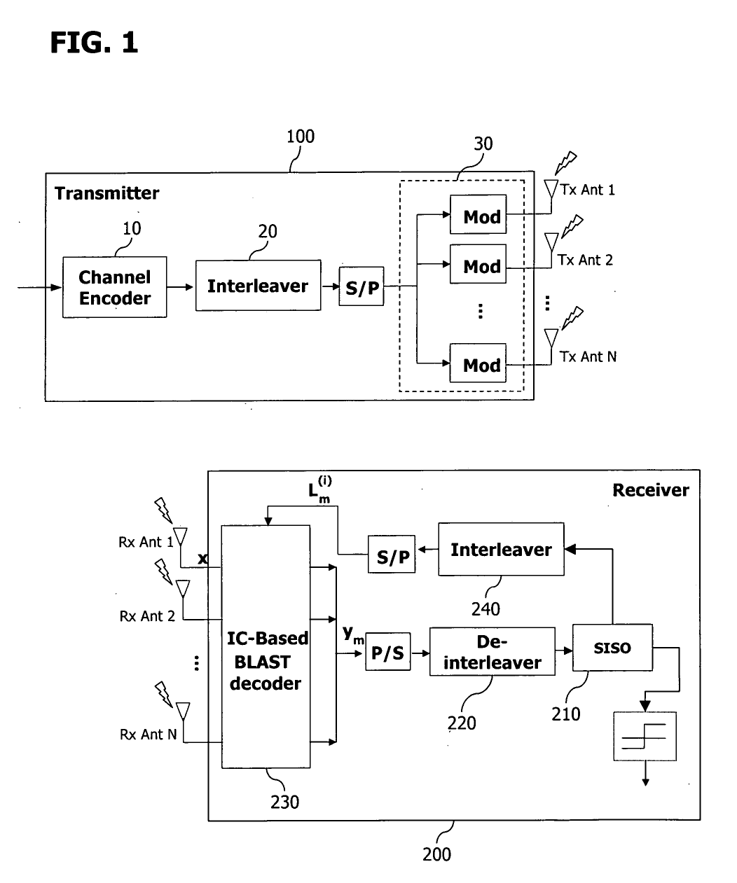

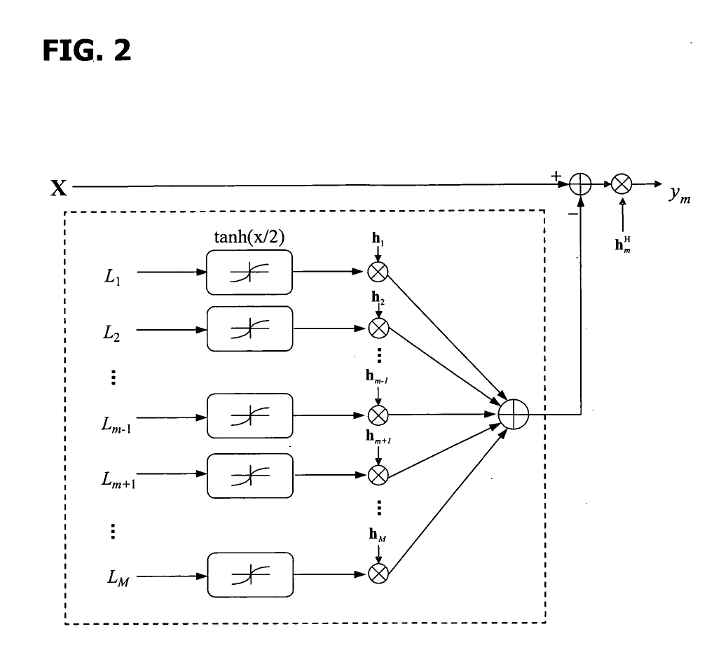

A basic structure of an SIC-TBLAST system of the present invention is the same as the PIC-TBLAST system as shown in FIG. 1, except that a structure of the BLAST decoder 230 is modified. A decoding method of the SIC-TBLAST system is a modification of an original V-BLAST decoding algorithm for applying iterative decoding.

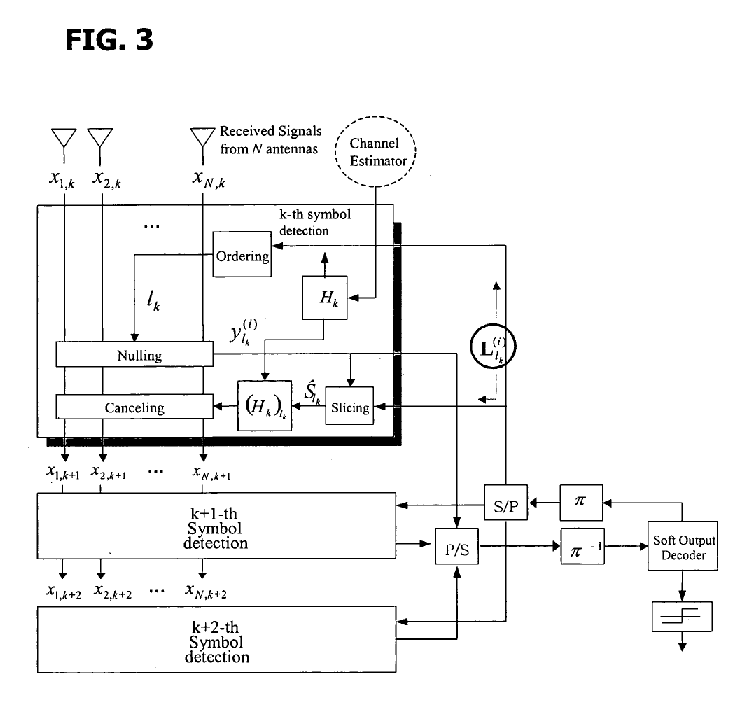

FIG. 3 illustrates a decoding process of the SIC-TBLAST system.

As shown in FIG. 3, the decoding process of the SIC-TBLAST system is divided into four parts of ordering, nulling, slicing and canceling.

The decoding process of the SIC-TBLAST system will now be described in detail with reference to FIG. 3.

When the kth decoding stage receives an output signal from the previous (k-1)th decoding stage, it performs ordering to select a layer (lₖ) with the lowest symbol error probability by using a channel value (Hₖ) and extrinsic information (Lₘ⁽ⁱ⁾). In order to reduce canceling error, the most reliable symbol should be preferentially decoded, so it is important to find the layer (lₖ) with the lowest symbol error probability.

A decoding order of the symbol is determined by an SINR (Signal-to-Interference-plus-Noise Ratio) and extrinsic information of each corresponding layer. The higher the SINR, the lower the symbol error rate. In addition, the higher reliability of the extrinsic information, the lower the symbol error rate. The reliability of the extrinsic information is increased as an absolute value of the size of the extrinsic information is large.

The related art V-BLAST performs ordering by using only the SINR, but in the present invention, ordering is performed by using both the SINR and extrinsic information. Translation of a reference of ordering as a minimum symbol error is also a difference from the related art method using the maximum SINR.

An ordering regulation in accordance with the present invention can be expressed by equation (2) shown below:

$${l}_{k} = {arg min}_{m} {P}_{m} ( e \vert {x}_{k} , {H}_{k} , {L}_{m}^{( i )} ) \qquad ( 2 )$$

wherein Hₖ is a channel matrix used in the kth decoding stage and Pₘ(e|xₖ, Hₖ, Lₘ⁽ⁱ⁾) is a conditional symbol error probability with respect to the mth layer. X_{n,k} means a signal which is received from the nth antenna, undergoes the k-1 decoding process, and then is inputted to the kth decoding stage. Lₘ⁽ⁱ⁾ is an extrinsic information vector, whose element is 1 in case of the BPSK(Binary Phase Shift Keying), 2 in case of the QPSK(Quadrature Phase Shift Keying) and 4 in case of the 16-QAM(Quadrature Amplitude Modulation). The ordering regulation is determined differently according to a modulation method, and each ordering regulation of the BPSK, QPSK and 16-QAM is as follows.
a)BPSK:

$${l}_{k} = {arg max}_{m} ( {σ}_{m} \vert {L}_{m}^{( i )} \vert + \frac{2}{{σ}_{m}} ) \qquad ( 3 )$$
b) QPSK:

$${l}_{k} = {arg max}_{m} ( {σ}_{m} min [ \vert {L}_{m , 1}^{( i )} \vert , \vert {L}_{m , 2}^{( i )} \vert ] + \frac{1}{{σ}_{m}} ) \qquad ( 4 )$$
c) 16-QAM is divided into an optimum method and a suboptimum method for lowering complexity of computation.
i. Optimum:

$${l}_{k} = {arg max}_{m} \{ {P}_{m , l} ( e \vert {x}_{k} , {H}_{k} , {L}_{m , 1}^{( i )} , {L}_{m , 2}^{( i )} ) , \\ {P}_{m , Q} ( e \vert {x}_{k} , {H}_{k} , {L}_{m , 3}^{( i )} , {L}_{m , 4}^{( i )} ) \} \qquad ( 5 )$$
ii. Suboptimum:

$${l}_{k} = {arg min}_{m} ( {σ}_{m}^{2} + {\sum }_{q = 1}^{Q} \frac{2}{\vert {L}_{m , q}^{( i )} \vert {Q}^{2}} ) \qquad ( 6 )$$

In equation (3) and (4), σₘ is a standard deviation of noise whose size has been changed by multiplying a nulling vector corresponding to the mth layer.

In equation (5),

$${P}_{m , l} ( e \vert {x}_{k} , {H}_{k} , {L}_{m , 1}^{( i )} , {L}_{m , 2}^{( i )} )$$

is a conditional symbol error probability of a value of I axis, and

$${P}_{m , Q} ( e \vert {x}_{k} , {H}_{k} , {L}_{m , 3}^{( i )} , {L}_{m , 4}^{( i )} )$$

is a conditional symbol error probability of a Q axis.

In equation (6), ‘Q’ is a value indicating the number of bits per symbol. In case of the 16-QAM, ‘Q’ has the value of 4.

When lₖ is determined through ordering, nulling is performed on the determined layer lₖ. The nulling of the present invention is the same as that used in the related art T-BLAST system and its regulation is expressed by equation (7) shown below:

$${y}_{{l}_{k}} = {( {H}_{k}^{†} )}_{{l}_{k}} {x}_{k} \qquad ( 7 )$$

When yₗ_{ₖ} is obtained through nulling, this signal (yₗ_{ₖ}) should be canceled from the signal Xₖ for a decoding operation to be performed on the next stage because yₗ_{ₖ} works as an interference to a different signal. In order to cancel yₗ_{ₖ} from Xₖ, a symbol (Ŝₗ_{ₖ}) corresponding to yₗ_{ₖ} should be re-generated first and then the generated symbol Ŝₗ_{ₖ}, should be extracted from Xₖ.

The re-generation process of the symbol (Ŝₗ_{ₖ}) corresponding to yₗ_{ₖ} is called a slicing or symbol decision. In case of re-generating the symbol in the iterative decoding, application of a soft decision, instead of a hard decision, is more effective in some cases, so both equation (8) and equation (9) are applied to the slicing regulation.
a) Using of the hard decision symbol:

$${\hat{s}}_{{l}_{k}} = {arg max}_{{ϕ}_{j} ∈ Φ} p ( {y}_{{l}_{k}} \vert {ϕ}_{j} ) p ( {ϕ}_{j} \vert {L}_{{l}_{k}}^{( i )} ) \qquad ( 8 )$$
b) Using of the soft decision symbol:

$${\hat{s}}_{{l}_{k}} = {\sum }_{{ϕ}_{j} ∈ Φ} {ϕ}_{j} \frac{p ( {y}_{{l}_{k}} \vert {ϕ}_{j} ) p ( {ϕ}_{j} \vert {L}_{{l}_{k}}^{( i )} )}{p ( {y}_{{l}_{k}} )} \qquad ( 9 )$$

When the symbol (Ŝₗ_{ₖ}) is re-generated through slicing, since the symbol (Ŝₗ_{ₖ}) is considered as an interference signal, it is canceled from the signal Xₖ. This process is called canceling and a canceling regulation can be expressed by equation (10) shown below:
xₖ₊₁=xₖ−Ŝₗ_{ₖ}(H)ₗ_{ₖ} (10)

And then, a channel vector corresponding to yₗ_{ₖ} is canceled from the entire channel, and decoding is performed on the (k+1)th stage.
Hₖ₊₁=(Hₖ)_{\overline{l}}_{ₖ} (11)

Thereafter, when symbol detection of every decoding stage is finished, symbol detection of a decoding stage with respect to a next reception signal vector starts. When decoding of every symbol of one frame is finished, the frame is 5 inputted to the channel decoder 210 after passing through the deinterleaver 220, and the channel decoder 210 generates extrinsic information (reliability value) with respect to the input signal. The generated extrinsic information is deinterleaved and re-inputted to the BLAST decoder 230.

The present invention proposes a different ordering regulation as expressed in equation (12) and equation (13) shown below:

$$\begin{matrix}{l}_{k} = {arg max}_{m} \{ {min}_{j} \{ \vert {L}_{m , 1}^{( i )} \vert , … , \vert {L}_{m , Q}^{( i )} \vert \} \} & ( 12 ) \\ {l}_{k} = {arg max}_{m} \{ {\sum }_{q} \vert {L}_{m , q}^{( i )} \vert \} & ( 13 )\end{matrix}$$

Equation (12) and equation (13) show the suboptimum method for lowering complexity of computation and considering deviation of implementation, which is a modification of equation (2).

Equation (12) and equation (13) select a layer with the highest extrinsic information value (reliability value). Equation (12) is a method for detecting the lowest extrinsic information values of each layer (including four pieces of extrinsic information), searching the greatest value of detected values, and selecting a corresponding layer. Equation (13) is a method for computing an average of absolute values of extrinsic information values (reliability values) included in each layer and selecting a layer with the greatest average value.

Equation (12) and equation (13) includes comparison operation without a dividing operation for average computation, a result value can be simply and quickly obtained.

When the ordering regulation of equation (12) and equation (13) are employed, a corresponding slicing regulation can be expressed by equation (14) and equation (15) shown below:
a) Using of hard decision symbol:

$${\hat{s}}_{{l}_{k}} = {arg max}_{{ϕ}_{j} ∈ Φ} p ( {ϕ}_{j} \vert {L}_{{l}_{k}}^{( i )} ) \qquad ( 14 )$$
b) Using of soft decision symbol:

$${\hat{s}}_{{l}_{k}} = {\sum }_{{ϕ}_{j} ∈ Φ} {ϕ}_{j} p ( {ϕ}_{j} \vert {L}_{{l}_{k}}^{( i )} ) \qquad ( 15 )$$

The above-described SIC-TBLAST can have a problem that its performance is not good at a high signal-to-noise ratio compared to the PIC-TBLAST. Thus, in order to guarantee stable and reliable communication in diverse environments, the present invention proposes the SIC-combined hybrid interference cancellation scheme.

The basic structure of the HIC-TBLAST system is the same as the PIC-TBLAST as shown in FIG. 1, except that the structure of the BLAST decoder 230 is modified. In this embodiment of the present invention, the BLAST decoder 230 has a hybrid structure combining the SIC scheme and the PIC scheme, consisting of two stages.

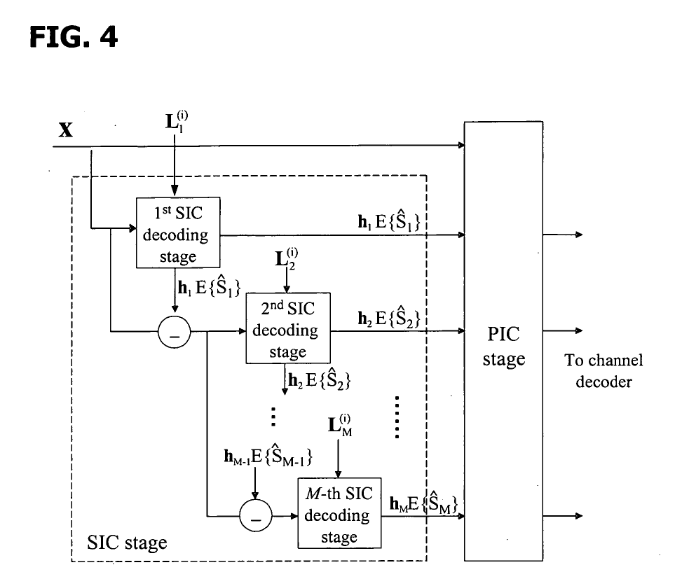

FIG. 4 illustrates a decoding process of the T-BLAST according to the hybrid interference cancellation scheme, in which when a SIC structure positioned at a front stage estimates an interference signal, a PIC structure positioned at a rear stage estimates an actual symbol.

With the description on the SIC-TBLAST system completed above, explanation for the HIC-TBLAST system is simple. That is, when the SIC stage estimates every interference signal by applying the afore-mentioned method, the PIC stage estimates a final symbol by using the estimated information instead of extrinsic information. The other remaining process is the same.

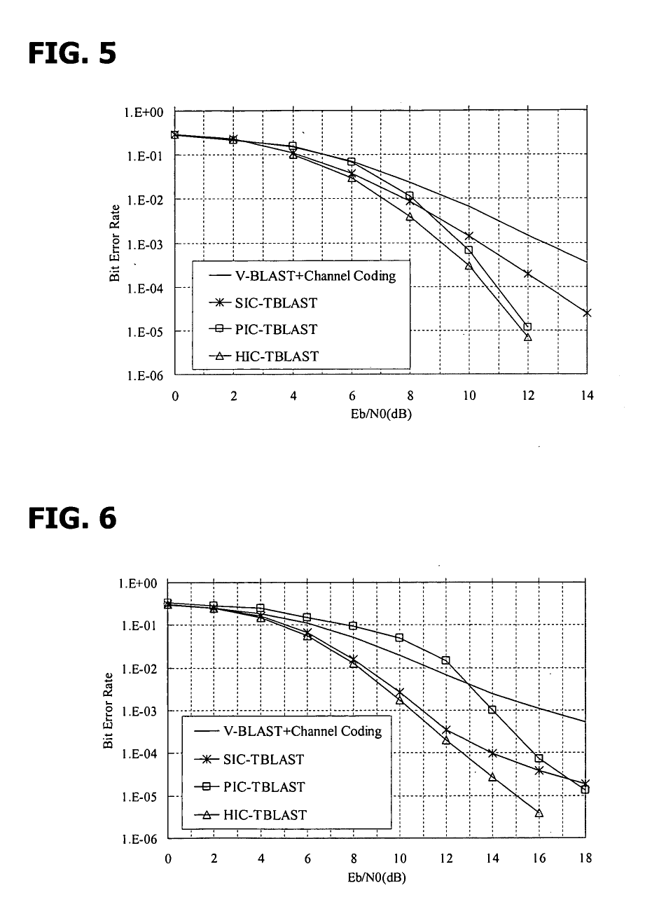

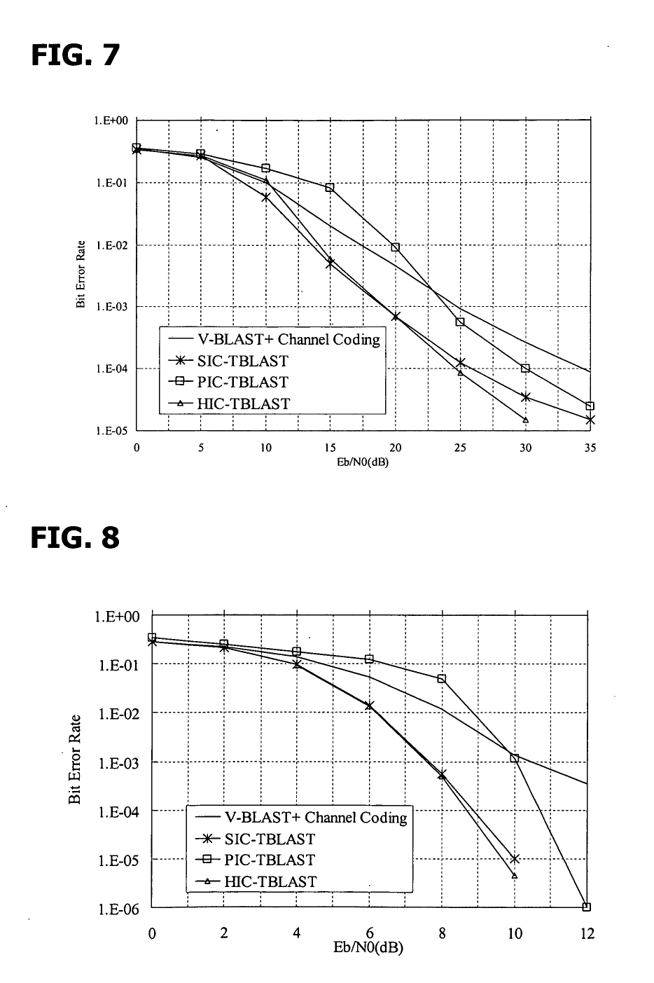

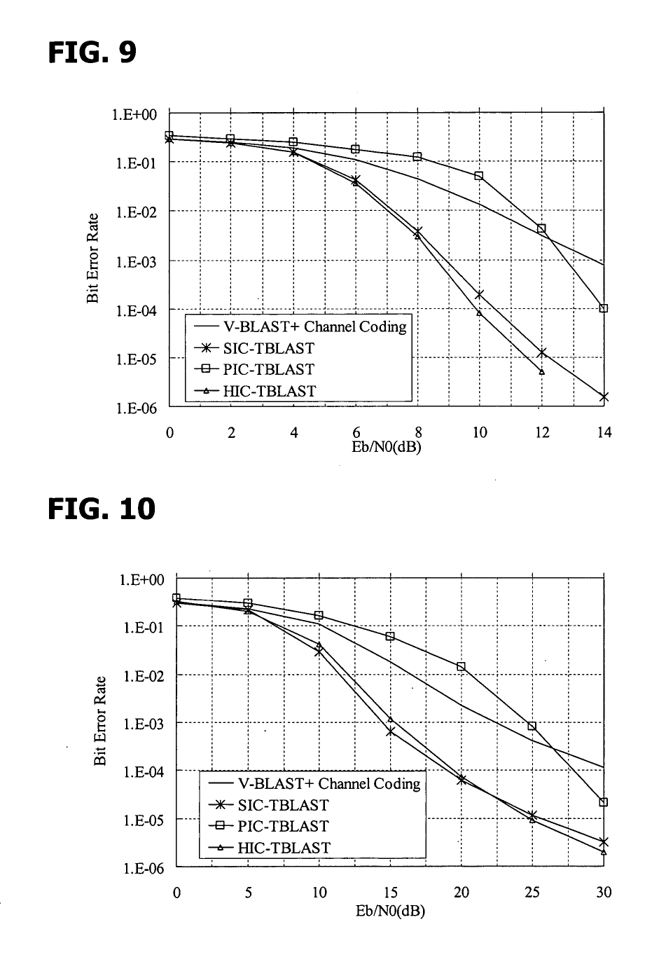

FIGS. 5 to 10 are graphs showing six simulation results, in which performance of PIC-TBLAST, SIC-TBLAST, HIC-TBLAST and V-BLAST+channel coding is compared by differing the structure of the system.

Below table shows the structure and environment of the system applied for the simulation.

TABLE

| | | i.i.d Block Rayleigh Fading |
|---|---|---|
| MIMO Channel | | Channel |
| MIMO | M × N | 4 × 4, 8 × 8 |
| System | Modulation | BPSK, QPSK, 16QAM |
| | Beamformer | MMSE |
| Channel | Channel Encoder | RSC (13, 15)₈ |
| Decoder | MAP algorithm | BCJR |
| | Iteration No. | 5 |
| | Interleaver | PN-random |
| | Frame Size | 100 |

Comparison between and analysis of the PIC-TBLAST and SIC-TBLAST based on the simulation result are as follows.

In case that there is no interference cancellation error, the PIC-TBLAST has a chi-squire distribution of about 2N and is free from interference. Meanwhile, the SIC-TBLAST has a chi-squire distribution of about 2(N−M+k) and has the (M−k) number of interferers (k: decoding stage).

As for the problem of propagation of an interference cancellation error, the PIC-TBLAST causes a serious problem at a low SNR, which becomes even more serious when a high-order modulation method is used according to an increase in the number of antennas. Comparatively, the SIC-TBLAST has a less problem.

In terms of BER performance, the PIC-TBLAST is good at a relatively high SNR, whereas the SIC-TBLAST is good at a relatively low SNR.

According to the analyses, the SIC-TBLAST and the PIC-TBLAST has a point where their graphs cross in terms of the BER, and the cross point is made differently according to the structure of the system. The more the number of antennas and the higher the order of the modulation, the cross point is moved toward a higher SNR.

Absolute comparison of performance between the SIC-TBLAST and the PIC-TBLAST is difficult. Generally, a communication system takes the most suitable SNR region according to its purpose or a structure form as an operation point and adjusts transmission power and a transmission standard to the operation point. In this case, a method exhibiting better performance at the operation point of the system is considered as a better method, the comparison is relative.

Meanwhile, the HIC-TBLAST exhibits the best performance at every case. Namely, the HIC-TBLAST shows similar characteristics to the SIC-TBLAST at the low SNR, similar characteristics to the PIC-TBLAST at the high SNR, and obtains a gain of about 3-5 dB compared to the SIC-TBLAST and PIC-TBLAST. Especially, compared to the related art method (V-BLAST+channel coding), the HIC-TBLAST obtains a gain of a maximum 10 dB.

As so far described, the apparatus and method for decoding a MIMO system has many advantages.

That is, for example, by employing the SIC-based iterative decoding algorithm in the T-BLAST system or by applying the SIC-based iterative decoding algorithm in combination with the PIC to the T-BLAST system, a high order of modulation method can be used or a high performance gain can be obtained in a transmission system having multiple antennas.

Especially, by combining the SIC to the PIC, merits of the two schemes have a synergy effect of obtaining high bit error performance in various wireless environments.

The foregoing embodiments and advantages are merely exemplary and are not to be construed as limiting the present invention. The present teaching can be readily applied to other types of apparatuses. The description of the present invention is intended to be illustrative, and not to limit the scope of the claims. Many alternatives, modifications, and variations will be apparent to those skilled in the art. In the claims, means-plus-function clauses are intended to cover the structure described herein as performing the recited function and not only structural equivalents but also equivalent structures.

1. A receiving apparatus of a MIMO system comprising:
a decoding unit for performing iterative decoding based on a serial concatenation interference cancellation scheme by using a reception signal vector and a reliability value;
a converting unit for converting an output of the decoding unit into a serial signal;
a deinterleaving unit for deinterleaving the serial signal; and
a channel decoding unit for obtaining a reliability value with respect to an output signal of the deinterleaving unit and outputting the reliability value to the decoding unit.

2. The apparatus of claim 1, wherein the decoding unit comprises:
an ordering unit for selecting a layer with the lowest symbol error is probability by using the reliability value and a channel vector;
a nulling unit for performing nulling on the selected layer;
a slicing unit for re-generating a symbol corresponding to a result value of the nulling;
a canceling unit for canceling a symbol corresponding to an interference signal, among re-generated symbols, from the reception signal.

3. The apparatus of claim 2, wherein the ordering is a step of selecting a layer with the greatest value of detected values after detecting the lowest reliability values among reliability values included in each layer.

4. The apparatus of claim 3, wherein the slicing unit re-generates a symbol according to an equation shown below:
$${\hat{s}}_{{l}_{k}} = {arg max}_{{ϕ}_{j} ∈ Φ} p ( {ϕ}_{j} \vert {L}_{{l}_{k}}^{( i )} ) ,$$
wherein Φ is a set of symbols of 2^{Q}-ary modulation, Lₗ_{ₖ}⁽ⁱ⁾ is a reliability value inputted to the lₖth layer (the selected layer) in the ith iterative decoding, and φⱼ is the jth element of Φ (0≦j<M=2^{Q}).

5. The apparatus of claim 3, wherein the slicing unit re-generates a symbol according to an equation shown below:
$${\hat{s}}_{{l}_{k}} = {\sum }_{{ϕ}_{j} ∈ Φ} {ϕ}_{j} p ( {ϕ}_{j} \vert {L}_{{l}_{k}}^{( i )} ) ,$$
wherein Φis a set of symbols of 2^{Q}-ary modulation, Lₗ_{ₖ}⁽ⁱ⁾ is a reliability value inputted to the lₖth layer (the selected layer) in the ith iterative decoding, and φⱼ is the jth element of Φ(0≦j<M=2^{Q}).

6. The apparatus of claim 2, wherein the ordering unit selects a layer with the greatest average value after calculating an average of the reliability values included in each layer.

7. The apparatus of claim 1, wherein the decoding unit performs ordering according to an equation shown below, under the BPSK(Binary Phase Shift Keying) modulation:
$${l}_{k} = {arg max}_{m} ( {σ}_{m} \vert {L}_{m}^{( i )} \vert + \frac{2}{{σ}_{m}} ) ,$$
wherein σₘ is a standard deviation of noise whose size has been changed by multiplying a nulling vector corresponding to the mth layer, and Lₘ⁽ⁱ⁾ is a reliability value inputted to the mth layer in the ith iterative decoding when 2^{Q}-ary modulation is used.

8. The apparatus of claim 1, wherein the decoding unit performs ordering according to an equation shown below, under the QPSK(Quadrature Phase Shift Keying) modulation:
$${l}_{k} = {arg max}_{m} ( {σ}_{m} min [ \vert {L}_{m , 1}^{( i )} \vert , \vert {L}_{m , 2}^{( i )} \vert ] + \frac{1}{{σ}_{m}} ) ,$$
wherein σₘ is a standard deviation of noise whose size has been changed by multiplying a nulling vector corresponding to the mth layer, and Lₘ⁽ⁱ⁾ is a reliability value inputted to the mth layer in the ith iterative decoding when 2^{Q}-ary modulation is used.

9. The apparatus of claim 1, wherein the decoding unit performs ordering according to an equation shown below, under the 16-QAM(Quadrature Amplitude Modulation) modulation:
$${l}_{k} = {arg min}_{m} \{ {P}_{m , l} ( e \vert {x}_{k} , {H}_{k} , {L}_{m , 1}^{( i )} , {L}_{m , 2}^{( i )} ) , \\ {P}_{m , Q} ( e \vert {x}_{k} , {H}_{k} , {L}_{m , 3}^{( i )} , {L}_{m , 4}^{( i )} ) \} ,$$
wherein
$${P}_{m , l} ( e \vert {x}_{k} , {H}_{k} , {L}_{m , 1}^{( i )} , {L}_{m , 2}^{( i )} )$$
is a conditional symbol error probability of I axis and
$${P}_{m , Q} ( e \vert {x}_{k} , {H}_{k} , {L}_{m , 3}^{( i )} , {L}_{m , 4}^{( i )} )$$
is a conditional symbol error probability of Q axis.

10. The apparatus of claim 9, wherein the decoding unit performs ordering according to an equation shown below in order to lower complexity of computation:
$${l}_{k} = {arg min}_{m} ( {σ}_{m}^{2} + {\sum }_{q = 1}^{Q} \frac{2}{\vert {L}_{m , q}^{( i )} \vert {Q}^{2}} ) ,$$
wherein σₘ is a standard deviation of noise whose size has been changed by multiplying a nulling vector corresponding to the mth layer, and Lₘ⁽ⁱ⁾ is a reliability value inputted to the mth layer in the ith iterative decoding when 2^{Q}-ary modulation is used.

11. The apparatus of claim 1, wherein the decoding unit re-generates a symbol by performing slicing according to an equation shown below:
$${\hat{s}}_{{l}_{k}} = {arg max}_{{ϕ}_{j} ∈ Φ} p ( {y}_{{l}_{k}} \vert {ϕ}_{j} ) p \text{(} {ϕ}_{j} \text{\vert} {L}_{{l}_{k}}^{( i )} \text{)} ,$$
wherein yₗ_{ₖ} is a result obtained by performing nulling on a signal of the lₖth layer, Φ is a set of symbols of a 2^{Q}-ary modulation method, Lₗ_{ₖ}⁽ⁱ⁾ is a reliability value inputted to the lₖth layer in the jth iterative decoding when the 2^{Q}-ary modulation method is used, and φⱼ is the jth element of Φ (0≦j<M=2^{Q}).

12. The apparatus of claim 1, wherein the decoding unit re-generates a symbol by performing slicing according to an equation shown below:
$${\hat{s}}_{{l}_{k}} = {\sum }_{{ϕ}_{j} ∈ Φ} {ϕ}_{j} \frac{p ( {y}_{{l}_{k}} \vert {ϕ}_{j} ) p \text{(} {ϕ}_{j} \text{\vert} {L}_{{l}_{k}}^{( i )} \text{)}}{p ( {y}_{{l}_{k}} )} ,$$
wherein yₗ_{ₖ} is a result obtained by performing nulling on a signal of the lₖth layer, Φ is a set of symbols of a 2^{Q}-ary modulation method, L_{ₖ}⁽ⁱ⁾ is a reliability value inputted to the lₖth layer in the ith iterative decoding, and φⱼ is the jth element of Φ (0≦j<M=2^{Q}).

13. A receiving apparatus of a MIMO system comprising:
a decoding unit for estimating an interference signal by performing serial interference cancellation scheme-based iterative decoding and performing parallel interference cancellation scheme-based iterative decoding based on the estimated value;
a converting unit for converting an output of the decoding unit into a serial signal;
a deinterleaving unit for deinterleaving the serial signal; and
a channel decoding unit for obtaining a reliability value of an output signal of the deinterleaving unit and outputting the reliability value to the decoding unit.

14. The apparatus of claim 13, wherein the decoding unit comprises:
a first decoding means for performing serial concatenation interference cancellation scheme-based iterative decoding by using a reception signal vector and the reliability value, and estimating an interference signal; and
a second decoding means for performing parallel concatenation interference cancellation scheme-based iterative decoding by using the reception signal vector and the estimated value of the first decoding means, and estimating an actual symbol.

15. The apparatus of claim 14, wherein the first decoding means comprises:
an ordering unit for selecting a layer with the lowest symbol error probability by using the reliability value and a channel vector;
a nulling unit for performing nulling on the selected layer;
a slicing unit for re-generating a symbol corresponding to a result value of the nulling; and
a canceling unit for canceling a symbol corresponding to an interference signal, among re-generated symbols, form the reception signal.

16. A decoding method of a MIMO system comprising:
performing iterative decoding based on a serial concatenation interference cancellation scheme by using a reception signal vector and a reliability value;
converting the decoded signal into a serial signal;
deinterleaving the serial signal; and
obtaining a reliability value of the deinterleaved signal and feeding the reliability value back to the iterative decoding step.

17. The method of claim 16, wherein the iterative decoding comprises:
performing ordering to select a layer with the lowest symbol error probability by using the reliability value and a channel vector;
performing nulling on the selected layer;
performing slicing to re-generate a symbol corresponding to a result value of the nulling; and
canceling a symbol corresponding to an interference signal, among re-generated symbols, from the reception signal.

18. The method of claim 17, wherein the ordering selects a layer with the greatest value of detected values after detecting the lowest reliability values among reliability values included in each layer.

19. The method of claim 18, wherein the slicing re-generates the symbol according to an equation shown below:
$${\hat{s}}_{{l}_{k}} = {arg max}_{{ϕ}_{j} ∈ Φ} p \text{(} {ϕ}_{j} \text{\vert} {L}_{{l}_{k}}^{( i )} \text{)} ,$$
wherein Φ is a set of symbols of 2^{Q}-ary modulation method, Lₗ_{ₖ}⁽ⁱ⁾ is the lₖth layer (the selected layer) in the ith iterative decoding, and φⱼ is the jth element of Φ (0≦j<M=2^{Q}).

20. The method of claim 18, wherein the slicing re-generates the symbol according to an equation shown below:
$${\hat{s}}_{{l}_{k}} = {\sum }_{{ϕ}_{j} ∈ Φ} {ϕ}_{j} p \text{(} {ϕ}_{j} \text{\vert} {L}_{{l}_{k}}^{( i )} \text{)} ,$$
wherein Φ is a set of symbols of 2^{Q}-ary modulation method, Lₗ_{ₖ}⁽ⁱ⁾ is the lₖth layer (the selected layer) in the ith iterative decoding, and φⱼ is the jth element Φ (0≦j<M=2^{Q}).

21. The method of claim 17, wherein the ordering selects a layer with the greatest average value after calculating an average of the reliability values included in each layer.

22. The method of claim 16, wherein the iterative decoding comprises ordering performed according to an equation shown below, under the BPSK modulation:
$${l}_{k} = {arg max}_{m} ( {σ}_{m} \vert {L}_{m}^{( i )} \vert + \frac{2}{{σ}_{m}} )$$
wherein σₘ is a standard deviation of noise whose size has been changed by multiplying a nulling vector corresponding to the mth layer, and Lₘ⁽ⁱ⁾ is a reliability value inputted to the mth layer in the ith iterative decoding when 2^{Q}-ary modulation is used.

23. The method of claim 16, wherein the iterative decoding comprises ordering performed according to an equation shown below, under the QPSK modulation:
$${l}_{k} = {arg max}_{m} ( {σ}_{m} min [ \vert {L}_{m , 1}^{( i )} \vert , \vert {L}_{m , 2}^{( i )} \vert ] + \frac{1}{{σ}_{m}} ) ,$$
wherein σₘ is a standard deviation of noise whose size has been changed by multiplying a nulling vector corresponding to the mth layer, and Lₘ⁽ⁱ⁾ is a reliability value inputted to the mth layer in the ith iterative decoding when 2^{Q}-ary modulation is used.

24. The method of claim 16, wherein the iterative decoding comprises ordering performed according to an equation shown below, under the 16-QAM modulation:
$${l}_{k} = {arg min}_{m} \{ {P}_{m , l} ( e \vert {x}_{k} , {H}_{k} , {L}_{m , 1}^{( i )} , {L}_{m , 2}^{( i )} ) , {P}_{m , Q} ( e \vert {x}_{k} , {H}_{k} , {L}_{m , 3}^{( i )} , {L}_{m , 4}^{( i )} ) \} ,$$
wherein
$${P}_{m , l} ( e \vert {x}_{k} , {H}_{k} , {L}_{m , 1}^{( i )} , {L}_{m , 2}^{( i )} )$$
is a conditional symbol error probability of I axis and
$${P}_{m , Q} ( e \vert {x}_{k} , {H}_{k} , {L}_{m , 3}^{( i )} , {L}_{m , 4}^{( i )} )$$
is a conditional symbol error probability of Q axis.

25. The method of claim 24, wherein the ordering is performed according to an equation shown below in order to lower complexity of computation:
$${l}_{k} = {arg min}_{m} ( {σ}_{m}^{2} + {\sum }_{q = 1}^{Q} \frac{2}{\vert {L}_{m , q}^{( i )} \vert {Q}^{2}} ) ,$$
wherein σₘ is a standard deviation of noise whose size has been changed by multiplying a nulling vector corresponding to the mth layer, and Lₘ⁽ⁱ⁾ is a reliability value inputted to the mth layer in the ith iterative decoding when 2^{Q}-ary modulation is used.

26. The method of claim 16, wherein the iterative decoding comprises slicing performed according to an equation shown below:
$${\hat{s}}_{{l}_{k}} = {arg max}_{{ϕ}_{j} ∈ Φ} p ( {y}_{{l}_{k}} \vert {ϕ}_{j} ) p ( {ϕ}_{j} \vert {L}_{{l}_{k}}^{( i )} ) ,$$
wherein yₗ_{ₖ} is a result obtained by performing nulling on a signal of the lₖth layer, Φ is a set of symbols of a 2^{Q}-ary modulation method, Lₗ _{ₖ}⁽ⁱ⁾ is a reliability value inputted to the lₖth layer in the ith iterative decoding when the 2^{Q}-ary modulation method is used, and φⱼ is the jth element of Φ (0≦j<M=2^{Q}).

27. A decoding method of a MIMO system comprising:
estimating an interference signal by performing serial interference cancellation scheme-based iterative decoding, and performing parallel interference cancellation scheme-based iterative decoding based on the estimated value;
converting the decoded signal into a serial signal;
deinterleaving the serial signal; and
feeding a reliability value of the deinterleaved signal back to the iterative decoding based on a serial interference cancellation.

28. The method of claim 27, wherein the estimating comprises:
performing serial concatenation interference cancellation scheme-based iterative decoding by using a reception signal vector and the reliability value, and estimating an interference signal; and
performing parallel concatenation interference cancellation scheme-based iterative decoding by using the reception signal vector and the estimated value, and estimating an actual symbol.

29. The method of claim 27, wherein the iterative decoding based on a serial interference cancellation comprises:
performing ordering to select a layer with the lowest symbol error probability by using the reliability value and a channel vector;
performing nulling on the selected layer;
performing slicing to re-generate a symbol corresponding to a result value of the nulling; and
canceling a symbol corresponding to an interference signal, among re-generated symbols, from the reception signal.

30. The method of claim 29, wherein the ordering selects a layer with the greatest value of detected values after detecting the lowest reliability values among reliability values included in each layer.

31. The method of claim 30, wherein the slicing re-generates the symbol according to an equation shown below:
$${\hat{s}}_{{l}_{k}} = {arg max}_{{ϕ}_{j} ∈ Φ} p ( {ϕ}_{j} \vert {L}_{{l}_{k}}^{( i )} ) ,$$
wherein Φ is a set of symbols of 2^{Q}-ary modulation method, Lₗ_{ₖ}⁽ⁱ⁾ is the lₖth layer (the selected layer) in the ith iterative decoding, and φⱼ is the jth element of Φ (0≦j<M=2^{Q}).

32. The method of claim 30, wherein the slicing re-generates the symbol according to an equation shown below:
$${\hat{s}}_{{l}_{k}} = {\sum }_{{ϕ}_{j} ∈ Φ} {ϕ}_{j} p ( {ϕ}_{j} \vert {L}_{{l}_{k}}^{( i )} ) ,$$
wherein Φ is a set of symbols of 2^{Q}-ary modulation method, Lₗ_{ₖ}⁽ⁱ⁾ is the lₖth layer (the selected layer) in the ith iterative decoding, and φⱼ is the jth element of Φ (0≦j<M=2^{Q}).

33. The method of claim 29, wherein the ordering selects a layer with the greatest average value after calculating an average of the reliability values included in each layer.

34. The method of claim 27, wherein the iterative decoding comprises ordering performed according to an equation shown below, under the BPSK modulation:
$${l}_{k} = {arg max}_{m} ( {σ}_{m} \vert {L}_{m}^{( i )} \vert + \frac{2}{{σ}_{m}} )$$
wherein σₘ is a standard deviation of noise whose size has been changed by multiplying a nulling vector corresponding to the mth layer, and Lₘ⁽ⁱ⁾ is a reliability value inputted to the mth layer in the ith iterative decoding when 2^{Q}-ary modulation is used.

35. The method of claim 27, wherein the iterative decoding comprises ordering performed according to an equation shown below, under the QPSK modulation:
$${l}_{k} = {arg max}_{m} ( {σ}_{m} min [ \vert {L}_{m , 1}^{( i )} \vert , \vert {L}_{m , 2}^{( i )} \vert ] + \frac{1}{{σ}_{m}} ) ,$$
wherein σₘ is a standard deviation of noise whose size has been changed by multiplying a nulling vector corresponding to the mth layer, and Lₘ⁽ⁱ⁾ is a reliability value inputted to the mth layer in the ith iterative decoding when 2^{Q}-ary modulation is used.

36. The method of claim 27, wherein the iterative decoding comprises ordering performed according to an equation shown below, under the 16-QAM modulation:
$${l}_{k} = {arg min}_{m} \{ {P}_{m , l} ( e \vert {x}_{k} , {H}_{k} , {L}_{m , 1}^{( i )} , {L}_{m , 2}^{( i )} ) , \\ {P}_{m , Q} ( e \vert {x}_{k} , {H}_{k} , {L}_{m , 3}^{( i )} , {L}_{m , 4}^{( i )} ) \} ,$$
wherein
$${P}_{m , l} ( e \vert {x}_{k} , {H}_{k} , {L}_{m , 1}^{( i )} , {L}_{m , 2}^{( i )} )$$
is a conditional symbol error probability of I axis and
$${P}_{m , Q} ( e \vert {x}_{k} , {H}_{k} , {L}_{m , 3}^{( i )} , {L}_{m , 4}^{( i )} )$$
is a conditional symbol error probability of Q axis.

37. The method of claim 36, wherein the ordering is performed according to an equation shown below in order to lower complexity of computation:
$${l}_{k} = {arg min}_{m} ( {σ}_{m}^{2} + {\sum }_{q = 1}^{Q} \frac{2}{\vert {L}_{m , q}^{( i )} \vert {Q}^{2}} ) ,$$
wherein σₘ is a standard deviation of noise whose size has been changed by multiplying a nulling vector corresponding to the mth layer, and Lₘ⁽ⁱ⁾ is a reliability value inputted to the mth layer in the ith iterative decoding when 2^{Q}-ary modulation is used.

38. The method of claim 27, wherein, the iterative decoding based on a serial interference cancellation comprises slicing performed according to an equation shown below:
$${\hat{s}}_{{l}_{k}} = {argmax}_{{ϕ}_{j} ∈ Φ} p ( {y}_{{l}_{k}} \vert {ϕ}_{j} ) p ( {ϕ}_{j} \vert {L}_{{l}_{k}}^{( i )} ) ,$$
wherein yₗ_{ₖ} is a result obtained by performing nulling on a signal of the lₖth layer, Φ is a set of symbols of a 2^{Q}-ary modulation method, Lₗ_{ₖ}⁽ⁱ⁾ is a reliability value inputted to the lₖth layer in the ith iterative decoding when the 2^{Q}-ary modulation method is used, and φⱼ is the jth element of Φ (0≦j<M=2^{Q})
